(19) United States
(12) Patent Application Publication
(10) Pub. No.: US 2019/0101911 A1
(43) Pub. Date: Apr. 4, 2019

(54) OPTIMIZATION OF VIRTUAL SENSING IN A MULTI-DEVICE ENVIRONMENT

(71) Applicant: PTC INC., Needham, MA (US)

(72) Inventor: Bruce F. Katz, Philadelphia, PA (US)

(21) Appl. No.: 16/149,878

(22) Filed: Oct. 2, 2018

Related U.S. Application Data
(60) Provisional application No. 62/567,147, filed on Oct. 2, 2017.

(51) Int. Cl. G05B 23/02; H04L 29/08; G06N 20/00; G06F 16/84; G06F 16/953

(52) U.S. Cl. CPC G05B 23/0251; G05B 23/0297; G06F 16/953; G06N 20/00; G06F 16/88; H04L 67/12

(57) ABSTRACT

A computer-implemented method producing an inductive virtual sensor model of a target device within an ecosystem of devices includes a computing system identifying a first subset of devices in the ecosystem of devices. Each device in the first subset comprises a target sensor and additional sensors. The computing system collects target sensor data from the target sensor of each device in the first subset of devices, and additional sensor data from the additional sensors of each device in the first subset. A predictive model is trained to predict the target sensor data based on the additional sensor data. The computing system identifies a second subset of devices in the ecosystem of devices lacking the target sensor. Each device in the second subset of devices comprises the plurality of additional sensors. The computing system distributes the predictive model to each device in the second subset of devices.

### CROSS REFERENCE TO RELATED APPLICATIONS

This application claims priority to U.S. Provisional Patent Application Ser. No. 62/567,147, filed on Oct. 2, 2017, the entire contents of which are hereby incorporated by reference herein.

### TECHNICAL FIELD

The present disclosure relates generally to methods, systems, and apparatuses for producing virtual sensors in a quasi-optimal fashion for a collection of related devices. The disclosed techniques may be applied to, for example, generate virtual sensors that detect vehicle engine characteristics, distribute these virtual sensors to existing engines, or install these virtual sensors in new engines before distribution of such.

### BACKGROUND

Virtual sensors are software-generated measurement systems that produce a real time measurement of a quantity. Two possible motivating factors drive the substitution of physical sensors with virtual sensors. First, physical sensors may be expensive to purchase, install, or maintain. Secondly, it may be inconvenient to implement a physical realization of a particular quantity. In both cases, the physical sensor can be approximated by less expensive, and more convenient to use, physical sensors and a model that generates the virtual sensor values from these physical sensors.

If there is sufficient a priori knowledge of a particular device, and the accompanying physics of the dynamics within the device, it may be possible to produce an analytic model of the virtual sensor from the actual sensors. For example, the temperature at every point in a vehicle engine may be approximated by a few temperature sensors accompanied by knowledge of the temperature diffusion characteristics of the materials in the engine.

However, in many cases, the appropriate background knowledge or the expertise to convert this knowledge into a working model is not present. In these cases, an inductive (or empirical) approach is warranted. Such an approach first constructs a model of the virtual sensor values from the actual sensors, and then continuously produces a series of scores (i.e., predictions) from this model meant to represent the value of the virtual sensor. The inductive approach, while not relying on subject-matter expertise, does rely on a training signal in order to construct the appropriate model. This training signal can only be derived from an actual physical sensor. Thus, even though the goal is to replace the physical sensor by a model, one cannot eliminate the use of target physical sensor entirely.

Conventional virtual sensor techniques employ a number of different supervised machine learning methods that may be used to construct such a model, including neural networks and support vector machines, although in principle any inductive technique may be used. Time-series methods such as deep learning that take into account past values of the actual sensors to predict the future value of the virtual sensor may improve the predictive accuracy of this method. Regardless of accuracy of the inductive technique, however, the conventional virtual sensor implementations largely ignore the fact that these supervised models of necessity rely on a training signal that originates from the actual physical sensor that will be replaced. This means that this presumably expensive sensor must be present at least during the training period, cancelling out any cost savings obtained by not having this sensor present.

Accordingly, it is desired to exploit the similarity between devices in an ecosystem in order to minimize the use of actual physical sensors, while accurately reproducing target sensor values.

### SUMMARY

Embodiments of the present invention address and overcome one or more of the above shortcomings and drawbacks, by providing methods, systems, and apparatuses related to producing a virtual sensor model and distributing this model to a collection of related devices. More specifically, the techniques described herein provide a solution to the more general problem of creating a virtual sensor for a distributed set of devices that are similar but not necessarily identical in nature. Optimization both with respect to training time, number of physical sensors needed for this training, and number and cost of actual sensors needed to generate the virtual sensor are also provided by the techniques described herein.

According to some embodiments, a computer-implemented method producing an inductive virtual sensor model of a target device within an ecosystem of devices includes a computing system identifying a first subset of devices in the ecosystem of devices. Each device in the first subset comprises a target sensor and additional sensors. The computing system collects target sensor data from the target sensor of each device in the first subset of devices, and additional sensor data from the additional sensors of each device in the first subset. A predictive model is trained to predict the target sensor data based on the additional sensor data. The computing system identifies a second subset of devices in the ecosystem of devices lacking the target sensor. Each device in the second subset of devices comprises the plurality of additional sensors. The computing system distributes the predictive model to each device in the second subset of devices.

According to other embodiments of the present invention, a computer-implemented method producing an inductive virtual sensor model of a target device within an ecosystem of devices includes a computing system grouping devices in the ecosystem of devices into a type-of hierarchy of devices. The computing system determines a measure of similarity between each node in the type-of hierarchy. A first subset of devices in the ecosystem of devices is identified. Each device in the first subset comprises a target sensor and additional sensors. The computing system collects target sensor data from the target sensor of each device in the first subset of devices, as well as additional sensor data from the additional sensors of each device in the first subset. A predictive model is trained to predict the target sensor data based on the additional sensor data. The computing system determines a first node in the type-of hierarchy corresponding to the first subset of devices, as well as a second node in the type-of hierarchy. The second node is selected such that the measure of similarity between the first node and the second node is above a predetermined threshold. The computing system identifies a second subset of devices in the ecosystem of devices that (a) correspond to the second node in the type-of hierarchy; (b) lack the target sensor; and (c) comprise the plurality of additional sensors. The computing system may then distribute the predictive model to each device in the second subset of devices.

In some embodiments of the second method described above, after collecting the additional sensor data, the computing system generates a listing of possible combinations of the additional sensors. Then, the computing system applies a heuristic search algorithm to the listing of possible combinations to identify an optimal combination of the additional sensors with respect to (i) number of sensors and (ii) ability to predict the target sensor data based on the additional sensor data. The computing system can then train the predictive model to predict the target sensor data based on the additional sensor data corresponding to the optimal combination of the additional sensors, rather than the full set of additional sensor data.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there are shown in the drawings embodiments that are presently preferred, it being understood, however, that the invention is not limited to the specific instrumentalities disclosed. Included in the drawings are the following Figures:

FIG. 1 illustrates a hypothetical device comprising four sensors represented in the diagram by their respective gauges;

FIG. 2 provides an example of training on a subset of devices and inheritance of the virtual sensor model by devices that were not explicitly trained;

FIG. 3 shows how predictive accuracy asymptotically approaches a constant value as more training devices are added to the training regime;

FIG. 4 shows an example device hierarchy in which two models z1, and z2, are variations on a more general device of type Z;

FIG. 5 illustrates a method for producing an inductive virtual sensor model of a target device within an ecosystem of similar devices, according to some embodiments;

FIG. 6 illustrates a computer-implemented method producing an inductive virtual sensor model of a target device within an ecosystem of devices, according to some embodiments; and

FIG. 7 provides an example of a parallel processing platform that may be utilized to implement the machine learning models and other aspects of the various sensor processing methods discussed herein.

### DETAILED DESCRIPTION

Systems, methods, and apparatuses are described herein which relate generally to various techniques for the optimization of virtual sensing in a multi-device environment (referred to herein as an “ecosystem”). More specifically, the techniques described herein may be applied to create a virtual sensor model for multiple devices of identical or similar behaviors such that the number of physical sensors needed to create this model is minimized. Other optimizations, including reduction in the number and cost of the physical sensors predicting the virtual sensor values, are also provided in various embodiments discussed herein.

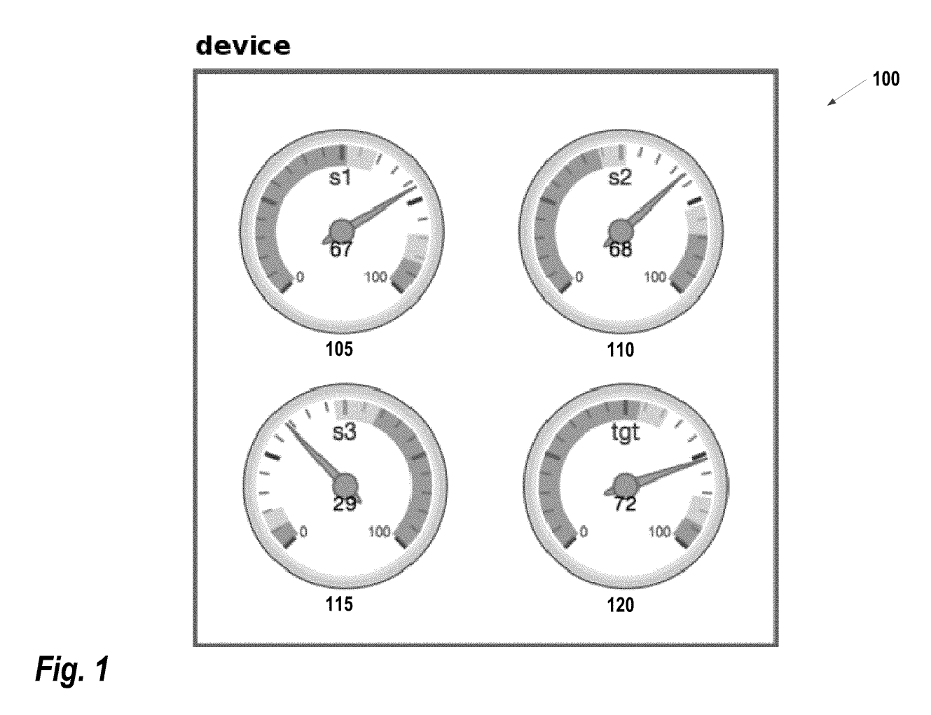

FIG. 1 shows a single device 100 with 4 gauges 105, 110, 115, and 120 corresponding to physical sensors. Gauge 120 corresponds to the target sensor, while gauges 105, 110, and 115 correspond to other less expensive sensors (referred to herein as sensors s1, s2, and s3, respectively). Given the cost difference between the various sensors, the virtual sensor techniques described herein may be employed to replace the target sensor by a model that generates the same or similar values as the target sensor using sensor values from sensors s1-s3. For example, assume that the values of sensors s1, s2, and s3 are vs1, vs2, and vs3, respectively. Further assume that it is known a priori that the target sensor had the value (vs1+vs2)/vs3 at all times of interest. In this case, there is no need for a physical target sensor because its value can be readily calculated using data from the other sensors. In most applications, such a priori knowledge is not available. To address this lack of knowledge, the techniques described herein use an inductive model constructed via training from the streams of data from the sensors.

The table below shows a hypothetical flat view of the training problem within this device 100:

time

| | 1 | 2 | 3 | 4 | 5 |
|---|---|---|---|---|---|
| sensor 1 | s₁₁ | s₁₂ | s₁₃ | s₁₄ | s₁₅ |
| sensor2 | s₂₁ | s₂₂ | s₂₃ | s₂₄ | s₂₅ |
| sensor 3 | s₃₁ | s₃₂ | s₃₃ | s₃₄ | s₃₅ |
| target sensor | t₁ | t₂ | t₃ | t₄ | t₅ |

For simplicity, the table only shows 5 discrete time steps. Each sensor i has a value sᵢⱼ at time j. In addition, the target sensor (i.e., the sensor to be virtualized) has a value tⱼ for time j.

For the purposes of training the virtual sensor model, this table can be rotated into the more typical form below:

| time | s1 | s2 | s3 | target sensor |
|---|---|---|---|---|
| 1 | s₁₁ | s₂₁ | s₃₁ | t₁ |
| 2 | s₁₂ | s₂₂ | s₃₂ | t₂ |
| 3 | s₁₃ | s₂₃ | s₃₃ | t₃ |
| 4 | s₁₄ | s₂₄ | s₃₄ | t₄ |
| 5 | s₁₅ | s₂₅ | s₃₅ | t₅ |

The purpose of the training is to produce a model that takes the sᵢⱼ values and produces a virtual value for the target sensor tⱼ for each time step j. In practice, many more such time steps would be used in training than are shown here. If these allow a sufficiently accurate model, then in the future the physical sensor producing the last column in this table can be removed, and can be substituted by the model itself.

Once the data is in this canonical form, various inductive training algorithms generally known in the art can be used to create a predictive model that generates target sensor values from the values of the other sensors. Example predictive models that may be used in different embodiments of the present invention include, without limitation, linear regression, neural networks, support vector machines, and gradient boost machines. The choice of inductive model will entail a trade-off between training time, the distribution of data in the training space, and the degree of predictive accuracy required.

In some embodiments, past values of the sensors may contain information that improves the accuracy of the model. For example, in the table below, the model is trained to generate a target sensor tⱼ from the current sensor value sᵢⱼ but also the last two values sᵢ₍ⱼ₋₁₎ and sᵢ₍ⱼ₋₂₎. For the purposes of training, rows corresponding to values occurring before recording began (shown here as “-”) can be ignored. Alternatively, values can be imputed such as the mean value for the sensor for these empty cells and training can include such rows.

| time | s1(t − 2) | s1(t − 1) | s1(t) | s2(t − 2) | s2(t − 1) | s2(t) | s3(t − 2) | s3(t − 1) | s3(t) | target sensor |
|---|---|---|---|---|---|---|---|---|---|---|
| 1 | — | — | s₁₁ | — | — | s₂₁ | — | — | s₃₁ | t₁ |
| 2 | — | s₁₁ | s₁₂ | — | s₂₁ | s₂₂ | — | s₃₁ | s₃₂ | t₂ |
| 3 | s₁₁ | s₁₂ | s₁₃ | s₂₁ | s₂₂ | s₂₃ | s₃₁ | s₃₂ | s₃₃ | t₃ |
| 4 | s₁₂ | s₁₃ | s₁₄ | s₂₂ | s₂₃ | s₂₄ | s₃₂ | s₃₃ | s₃₄ | t₄ |
| 5 | s₁₃ | s₁₄ | s₁₅ | s₂₃ | s₂₄ | s₂₅ | s₃₃ | s₃₄ | s₃₅ | t₅ |

Time series methods generally known in the art such as the deep-learning Long short-term memory (LSTM) algorithm may be then used to produce such a model from such a table. Note, however, that unlike in a typical time series problem which can profit by use of the so-called autoregressive past values of the data stream to be predicted, past values of the target sensor do not find their way into the transformed table in virtual sensor time-series training. The reason for this is that when the sensor is removed, these values will be unavailable; that is, there will be no physical sensor present generating past values, and the model must therefore rely on past (or present) values of the other sensors s1-s3 alone.

It is important to realize that, regardless of the transforms and algorithms applied, the values in the column for the virtual target sensor can only be filled in by having an actual physical sensor in place for a period of time. This forms the crux of the problem addressed by the technology described herein. Specifically, if there are a collection of devices with similar operating characteristics, one would have to install an actual sensor in each device to obtain the training column and then remove it to form the best set of virtual sensors for these devices. However, this defeats the purpose of replacing an actual sensor by a virtual model because this method would require n physical target sensors for n devices and result in no savings whatsoever.

One solution is to move a single actual sensor from device to device and train the virtual model in a sequential fashion. But this is costly from both the point of view of logistics and time. Consider that there may be n devices, and the training time for each on average is m seconds, with a mean transfer and installation time of p seconds. Then the total training time over the set of n devices is n*(m+p). One could decrease total training time by using more than one actual sensor at once, training on a subset, moving to new subset, etc., until all devices are trained; however this will entail greater investment in the presumably expensive physical sensor to be virtualized.

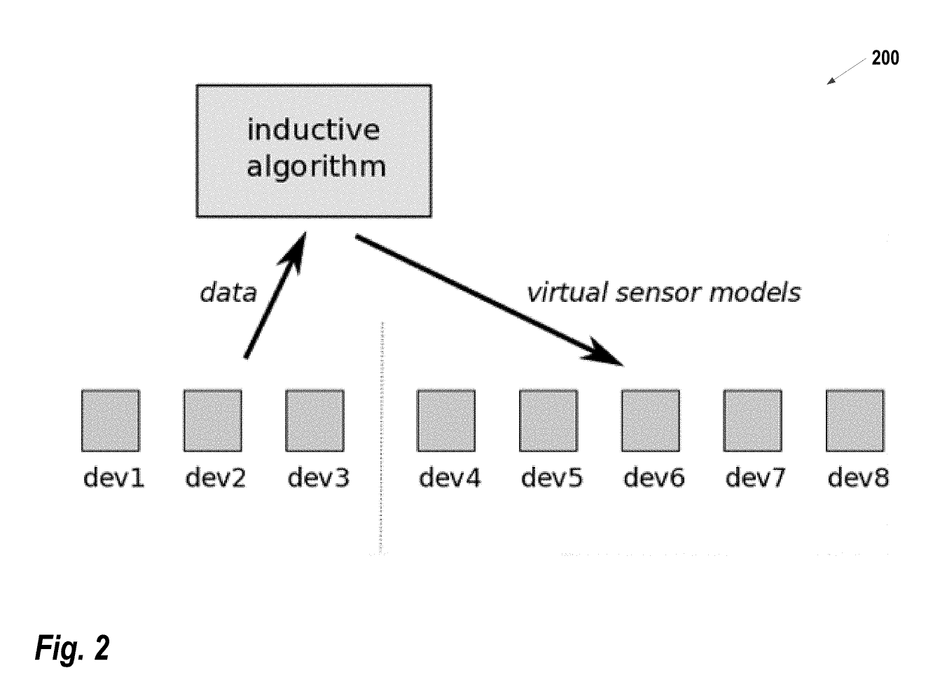

FIG. 2 shows an alternative method 200 that exploits that fact that similarity between devices means that it is not necessary to train on all of the devices to produce a virtual sensor model. The example of FIG. 2 shows the inductive training algorithm operating on data obtained from devices dev1-dev3. Once a virtual model is constructed from these devices, it can be inherited by devices dev4-dev8, without the need to explicitly include the physical sensor to be trained on these devices. This concept can be generalized as follows. Let there be n devices with similar operating characteristics, and choose a small representative subset m of those devices for training. Aggregate the data from the subset m for training purposes. Once the virtual sensor model is constructed from this aggregated data, let the remaining n−m devices inherit this model. If m is sufficiently small, the cost of training sensors will also be small, and moreover, all training can proceed in parallel, thus incurring minimal training time costs.

The method illustrated in FIG. 2 produces the aggregated training table shown below. Here, both the sᵢⱼ and tⱼ's for different devices are also assumed to be different, corresponding to the unique conditions on each device.

| Device | time | s1 | s2 | s3 | target sensor |
|---|---|---|---|---|---|
| 1 | 1 | s₁₁ | s₂₁ | s₃₁ | t₁ |
| 1 | 2 | s₁₂ | s₂₂ | s₃₂ | t₂ |
| 1 | 3 | s₁₃ | s₂₃ | s₃₃ | t₃ |
| 1 | 4 | s₁₄ | s₂₄ | s₃₄ | t₄ |
| 1 | 5 | s₁₅ | s₂₅ | s₃₅ | t₅ |
| 2 | 1 | s₁₁ | s₂₁ | s₃₁ | t₁ |
| 2 | 2 | s₁₂ | s₂₂ | s₃₂ | t₂ |
| 2 | 3 | s₁₃ | s₂₃ | s₃₃ | t₃ |
| 2 | 4 | s₁₄ | s₂₄ | s₃₄ | t₄ |
| 2 | 5 | s₁₅ | s₂₅ | s₃₅ | t₅ |
| 3 | 1 | s₁₁ | s₂₁ | s₃₁ | t₁ |
| 3 | 2 | s₁₂ | s₂₂ | s₃₂ | t₂ |
| 3 | 3 | s₁₃ | s₂₃ | s₃₃ | t₃ |
| 3 | 4 | s₁₄ | s₂₄ | s₃₄ | t₄ |
| 3 | 5 | s₁₅ | s₂₅ | s₃₅ | t₅ |

As before, this table is a simplified version of the actual training data; in most actual cases, there would be many more than 3 training devices, and many more than 5 examples in each. In addition this table may be expanded in a time-series fashion as described above. This illustrates the fundamental aggregation technique: rows of data, each comprising the values of the predicting sensors and with a single target sensor values, may be extracted from each device and appended to form a larger table. This table then includes a new and larger training set than could be produced from a single device, and therefore thus a model that is presumably with greater generalizability to the devices for which training is not explicitly carried out.

Typically, the first column with the device number will be ignored in this training process as it cannot be generalized to other devices. However, in some embodiments, aggregation with static features that are informative may occur. This is illustrated in the table below, showing the identical table from above, but augmented by a feature indicating whether the device is in a factory setting or not.

| Device | in factory? | time | s1 | s2 | s3 | target sensor |
|---|---|---|---|---|---|---|
| 1 | yes | 1 | s₁₁ | s₂₁ | s₃₁ | t₁ |
| 1 | yes | 2 | s₁₂ | s₂₂ | s₃₂ | t₂ |
| 1 | yes | 3 | s₁₃ | s₂₃ | s₃₃ | t₃ |
| 1 | yes | 4 | s₁₄ | s₂₄ | s₃₄ | t₄ |
| 1 | yes | 5 | s₁₅ | s₂₅ | s₃₅ | t₅ |
| 2 | no | 1 | s₁₁ | s₂₁ | s₃₁ | t₁ |
| 2 | no | 2 | s₁₂ | s₂₂ | s₃₂ | t₂ |
| 2 | no | 3 | s₁₃ | s₂₃ | s₃₃ | t₃ |
| 2 | no | 4 | s₁₄ | s₂₄ | s₃₄ | t₄ |
| 2 | no | 5 | s₁₅ | s₂₅ | s₃₅ | t₅ |
| 3 | yes | 1 | s₁₁ | s₂₁ | s₃₁ | t₁ |
| 3 | yes | 2 | s₁₂ | s₂₂ | s₃₂ | t₂ |
| 3 | yes | 3 | s₁₃ | s₂₃ | s₃₃ | t₃ |
| 3 | yes | 4 | s₁₄ | s₂₄ | s₃₄ | t₄ |
| 3 | yes | 5 | s₁₅ | s₂₅ | s₃₅ | t₅ |

Note that this static feature does not change from time step to time step within a device. It may vary from device to device, however, and this variation may be useful in generalizing to new devices on which the virtual sensor has not been explicitly trained.

In some embodiments, the locus of aggregation will be the cloud rather than an explicit data repository in a server connected in a physical manner to the devices in question. The advantages of aggregating data and training the model in the cloud are numerous and include the ability to easily combine data from diverse geographic locations, the ability to process large amount of data during training without the need to purchase permanent processing power for this spurt of activity, and access to a number of standard database and training regimes without the need to maintain such.

In yet another embodiment, the adequate subsample of devices is made empirically. Recall that the goal is to reduce the number of devices involved in training as much as possible, in order to minimize training cost. However, if too few devices are used, the resulting virtual sensor model will not generalize well to the untrained devices. There may be situations, for example, that do not appear in a single or small number of devices because of, for example, changes arising in the manufacturing process or differences in background conditions. When these conditions arise on the m untrained devices, predictive accuracy may be poor because they have not been previously encountered.

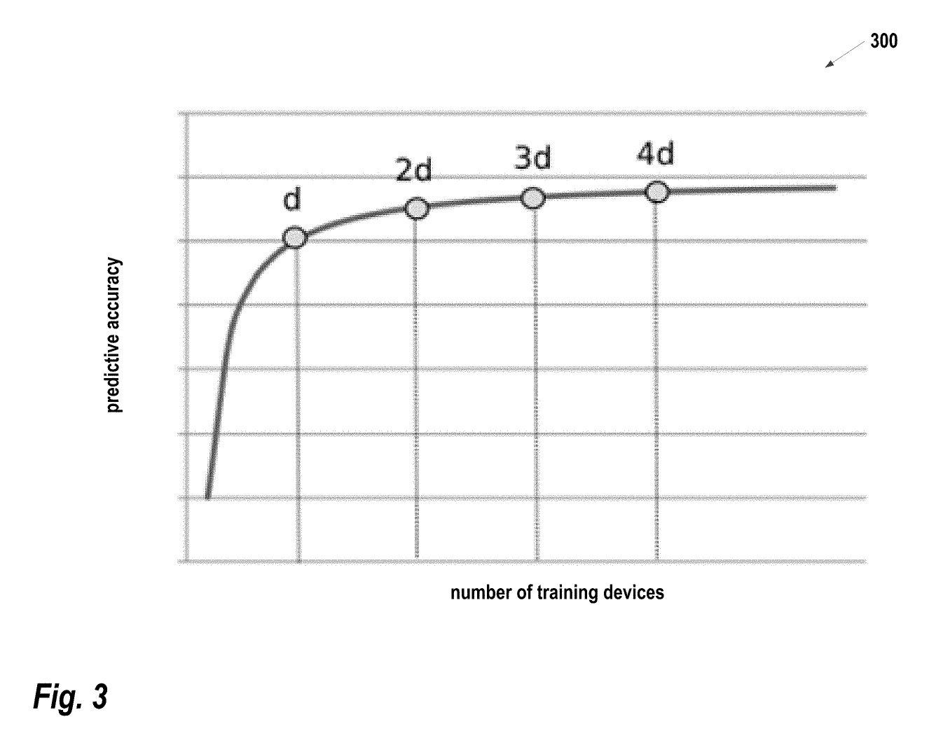

FIG. 3 illustrates one empirical technique for assessing whether sufficient devices have been included in training, according to some embodiments. Here, training is carried out by multiples of d devices. For each such set, predictive accuracy is assessed. This may be accomplished, for example, by withholding a subset of data from submission to the training algorithm, scoring this data, and measuring the root-mean-square error (RMSE) between these predicted scores and the actual scores, or by determining the Pearson correlation between the set of prediction and actual scores. As devices are added to training set, the learning curve will asymptotically approach a maximal value. The termination condition for training is when there are diminishing returns with respect to predictive accuracy obtained by adding an additional d devices. In practice, this can be determined by examining the increase in predictive accuracy from one training set to the next; if this increase is sufficiently small, training may be safely terminated.

Once a virtual sensor model has been created, regardless of both the method for doing so and the physical substrate upon which this carried out, the model can be distributed to the other devices for which training was not explicitly carried out. This distribution can be done by the normal channels of distributing software, or via downloading from the cloud as appropriate. Various formats generally known in the art may be used for distributing the model. For example, in some embodiments, the model is distributed via Predictive Model Markup Languages (PMML). Techniques such as PMML have the benefit that they efficiently compress a potentially large amount of information. It should be noted that, regardless of the format employed for distribution, the target devices would need to be equipped to run models encoded in the distribution format.

It should also be noted that, although this distribution can include future devices that have not yet been built (assuming they are of the same type), this extends the range of applicability of this method. For example, if the original data was derived from a subset of 50 engines from a total of 1000, the virtual sensor model can be inherited by not only the remaining 1000−50=950 engines, but also new engines of this type that are constructed after the training takes place.

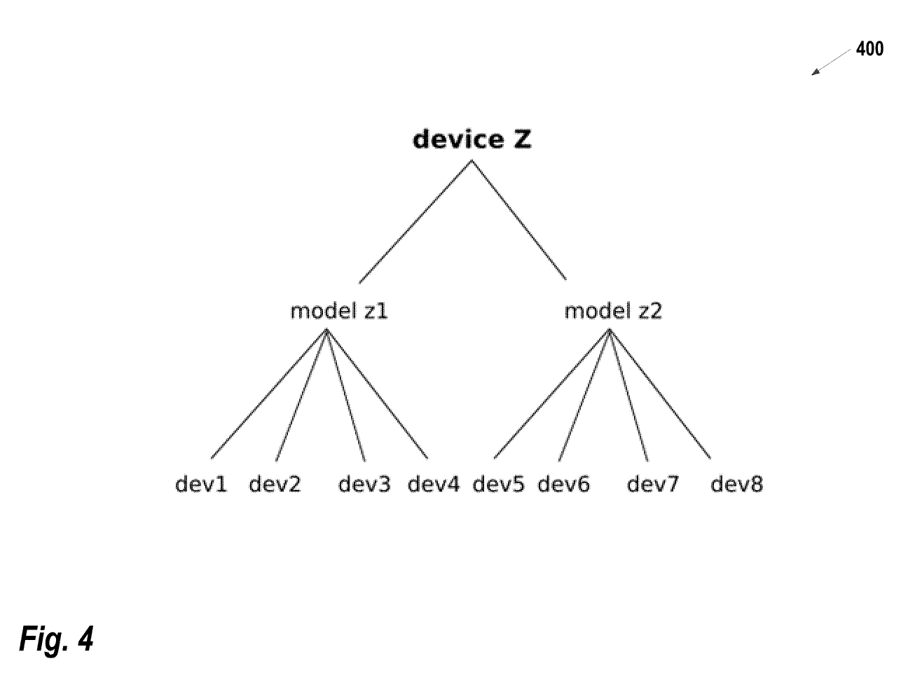

In the discussion presented above, it was assumed that all devices were identical in nature. However, there may be cases wherein devices that are similar but not identical can benefit from the created sensor model. For example, FIG. 4 shows a simple device hierarchy, wherein engine models z1 and z2 are small variations on each other; both are of a more general type Z. A hierarchy of this form is referred to herein as a “type-of hierarchy.” Devices may be grouped into a type-of hierarchy, for example, by analyzing documentation, serial numbers, or other data related to the device and comparing that information to a database of known characteristics to assess type relationships. Once these relationships are known, the devices can be arranged accordingly. In the hierarchy displayed in FIG. 4, let us assume that engine model z2 comes online much later than z1. It may be possible to immediately use the virtual sensor model(s) created for model z1 without further training, depending on how different z1 is from z2. In the case of doubt, a small set of data may be collected from the z2 engines with the actual sensor in place, to verify that this transfer of models across the hierarchy in FIG. 4 is warranted. If z1 and z2 are produced at the same time, it may be advantageous to take an aggregate from a sample derived from both.

This analysis also may be extended to more complex hierarchies, although more caution should be exercised when the distance in the hierarchy between devices is greater. For example, the mere fact that two different engines are produced by the same manufacturer will not, in general, be sufficient motivation for the transfer of virtual sensor models between such engines, unless there is sufficient a priori knowledge to conclude that they are sufficiently similar or the virtual sensor model produced from the data from one engine is validated on data from the other engine.

In some embodiments, each physical device may include a file indicating its compatibility with certain models or model types. As a particular device is connected to the network or otherwise gets activated, the computing system performing the modeling may retrieve the file and decide how to model the device. To continue with the example in FIG. 4, assume that the physical design of dev4 is different than that of dev1, dev2, dev3. For example, dev4 may be a newer model than the other devices, or dev4 may be made a different manufacturer than the other devices. Despite these differences, dev4 may include a file indicating that it is compatible with model z1 for the purpose of virtual sensor collection. Thus, a computer modeling dev4 may communicate with dev4 to retrieve the local file indicating its compatibility with models of type z1. Alternatively, the file may indicate that dev4 is compatible with devices of type dev1, dev2, and dev3 and the computer may use this information to infer that dev4 is compatible with model z1. In some embodiments, rather than store the compatibility information on the device itself, the knowledge may be derived by the modeling computing system. For example, the modeling computing system may store information describing compatibility of various device types and as new devices are detected, their characteristics are used to determine model compatibility.

The techniques described above are concerned with the production of a virtual sensor model from the entire collection of physical sensors present on a device. When the aggregated data is translated into tabular format as in the tables presented above, this becomes a matter of applying a standard predictive algorithm to this table. But, as in any learning process, some columns of the table may add little or nothing to the predictive power of the resulting model, and may be removed. In this case, the corresponding sensors may also be removed, unless they have an intrinsic value. That is, unless a sensor is needed to predict the virtual sensor value, or has some other use, such a sensor may be eliminated on all devices, resulting in further cost savings.

In one embodiment, columns in the training table, and the corresponding sensors, can be eliminated by removing all those with mutual information with respect to the training column, (i.e., virtual sensor column) below a given threshold, or by matrix reduction techniques such as principal component analysis (PCA) that retain only those columns whose contribution to these components is above a given threshold.

In another embodiment, the optimal set of columns (and therefore the optimal set of predictive sensors) is not removed before training as described above. Rather, a search is conducted of the training space over the best set of predictive sensors. Then, the set that provides the highest predictive accuracy with the least number of such sensors is retained. That is, multiple trainings are conducted, each corresponding to the one subset of the powerset of the predictive sensors. For example, with 3 sensors a, b, and c, the powerset comprises the set of 7 elements {{a}, {b}, {c}, {ab}, {ac}, {bc}, {abc}}. The table below shows this powerset, and hypothetical Pearson correlation values between the set of predicted and actual virtual sensor values.

| Sensor set | Pearson |
|---|---|
| a | .45 |
| b | .52 |
| c | .32 |
| a, b | .57 |
| a, c | .81 |
| b, c | .87 |
| a, b, c | .89 |

In this case, the set {b,c} is the most accurate of the two sensor pairs. The full set {a,b,c} adds only marginally to the predictive power of the model, so the presumably less expensive set {b,c} may be used to predict the virtual sensor, unless sensor {a} has intrinsic value and therefore is in use already. Because there are on the order of 2ⁿ elements in this powerset, where n is the number of predictive sensors, this method is very costly for n>5 or so. Thus, in some embodiments, approximate heuristic methods can be used. One such method is a beam search that identifies the best m of n sensors initially, then the best m of combinations of 2 sensors, etc., until the desired number of sensors is reached. Other heuristic search techniques generally known in the art may applied in other embodiments.

In another embodiment, the utility function guiding the search is not the total number of sensors, but the total cost. Here, the objective is to produce the most accurate virtual sensor model such that the combined cost of the predictive sensors is under a pre-specified threshold. As before, a number of heuristic search techniques generally known in the art can be used. The result of this search process will be a collection of systems that accurately predicts, in the ideal case, the values of the expensive virtual sensor with a collection of low-cost sensors. For example, suppose the maximum allowable cost is $42. The table below shows both predictive power as revealed by the Pearson correlation between predicted and actual sensor values, and the cost of the sensor combinations.

| Sensor set | Pearson | Cost |
|---|---|---|
| a | .45 | $12 |
| b | .52 | $18 |
| c | .32 | $29 |
| a, b | .57 | $30 |
| a, c | .81 | $41 |
| b, c | .87 | $47 |
| a, b, c | .89 | $59 |

The cost threshold eliminates the last two rows of the table, and the best predictive set of the remaining rows will therefore be {a,c}.

In another embodiment, the utility function is a combination of cost and predictive accuracy, and the search is conducted with this as the guiding evaluation function. Again, the goal is to predict the virtual sensor by low cost, but in this case, depending on the weight given in the utility function to predictive accuracy, medium cost solutions with greater accuracy may be preferred. In some embodiments, this search or the analogous search for a minimal number of sensors regardless of cost may be accelerated by distributing each element in the powerset to a unique processor for evaluation; these evaluation steps are completely independent of each other and therefore completely parallelizable.

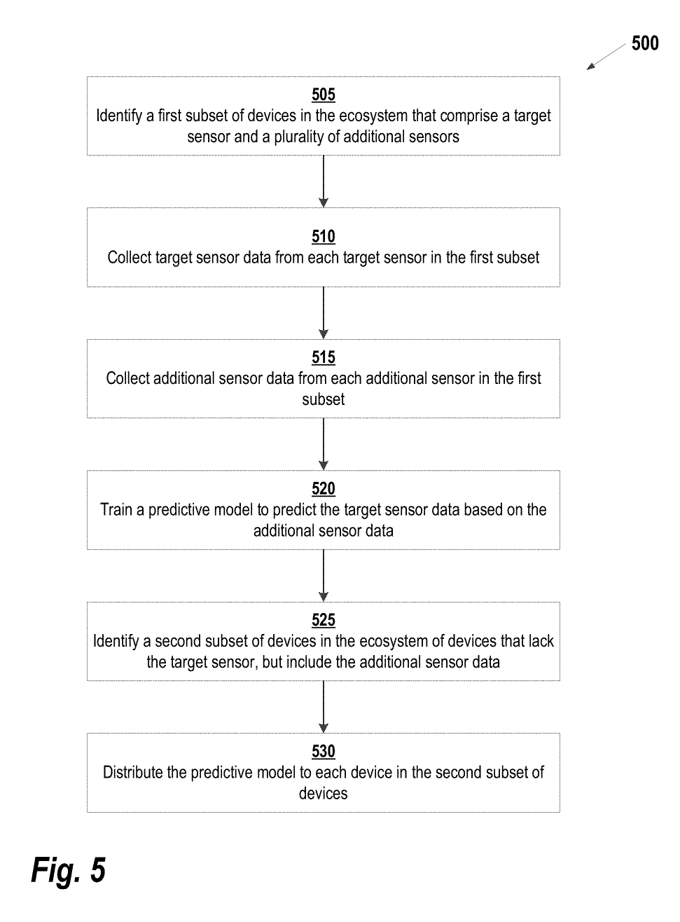

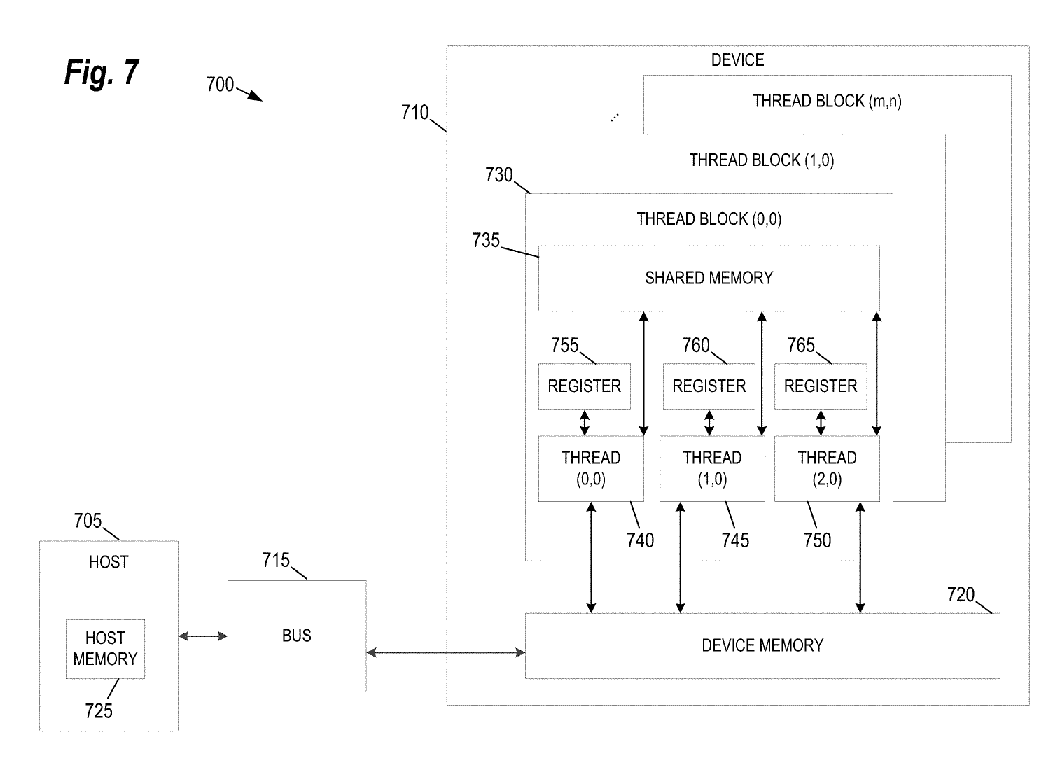

FIG. 5 illustrates a method 500 for producing an inductive virtual sensor model of a target device within an ecosystem of similar devices, according to some embodiments. This method 500 may be performed, for example, by a cloud-based computing system communicating with the devices over one or more networks (e.g., the Internet) or a parallel processing computing system (see, e.g., FIG. 7). Starting at step 505, the computing system identifies a first subset of devices in the ecosystem that comprise a target sensor and a plurality of additional sensors. In some embodiments, the computing system identifies the first subset by searching a database of device information. In other embodiments, the devices themselves, or another external source, is queried to receive device configuration information that, in turn, is used to identify the first subset.

At step 510, with the first subset identified, the computing system collects target sensor data from the target sensor of each device in the first subset of devices. Then, at step 515, additional sensor data is collected from the additional sensors of each device in the first subset. In some embodiments, each device is configured to push its sensor data to the computing system as its generated or at regular intervals (e.g., hourly). In other embodiments, the computing system communicates with each device (e.g., over the Internet) to retrieve one or more files including the sensor data. Once the additional sensor data is retrieved, at step 520, a predictive model is trained to predict the target sensor data based on the additional sensor data.

Once the predictive model is trained, it may be used to create a “virtual sensor” that takes the place of the target sensor. Continuing with reference to FIG. 5, at step 525, the computing system identifies a second subset of devices in the ecosystem of devices that lack the target sensor, but include the additional sensor data. The techniques described above with respect to step 505 may be applied similarly at step 525. Thus, for example, the second subset can be identified by querying a local database or by retrieving configuration data from devices in the ecosystem. Finally, at step 530, the computing system distributes the predictive model to each device in the second subset of devices. Each device in the second subset can include local software that allows it to utilize the predictive model locally as a replacement for the target sensor. That is, using the predictive model, devices in the second subset can generate target sensor data using the predictive model and, thus, provide similar sensor data to the devices in the first subset of devices. In some embodiments, the predictive model can be distributed manually to each device (e.g., via an SD card or other portable computer readable medium). In other embodiments, the predictive model can automatically be transferred to the device using whatever networking capabilities are available on the device (e.g., Wi-Fi).

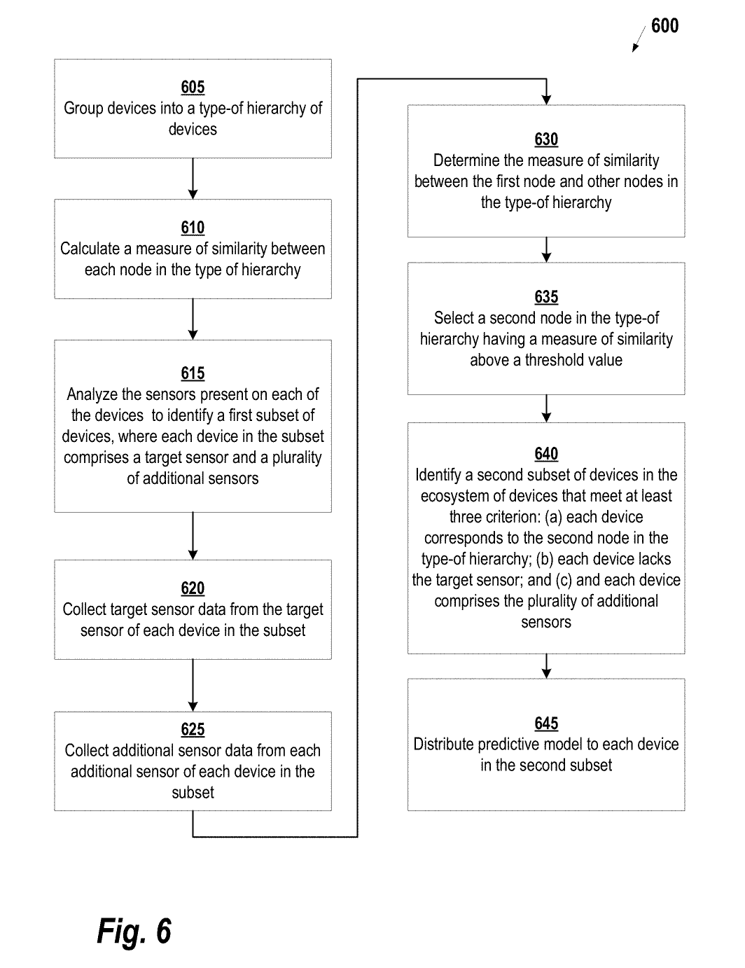

FIG. 6 illustrates a computer-implemented method 600 for producing an inductive virtual sensor model of a target device within an ecosystem of devices, according to some embodiments. This method 600 may be performed, for example, by a cloud-based computing system communicating with the devices over one or more networks (e.g., the Internet) or by a parallel processing computing system (see, e.g., FIG. 7). Starting at step 605, devices in the ecosystem of devices are grouped into a type-of hierarchy of devices. As described above, the type-of hierarchy organizes devices into nodes based on device types and subtypes. After the hierarchy has been generated, at step 610, the computing system calculates a measure of similarity between each node in the type-of hierarchy. The similarity measurement is a distance with dimensions representing hardware and/or software features of the devices. For example, two devices that differ only their processor type would have a higher measure of similarity than two devices that differ in their processor type and additional components (e.g., power adapter, networking modules, etc.). Various techniques known in the art may be used for calculating the measure of similarity including, without limitation, techniques based Euclidean distance, Manhattan distance, Minkowski distance, and Cosine similarity.

Continuing with reference to FIG. 6, at step 615, the computing system executing the method 600 analyzes the sensors present on each of the devices in the ecosystem to identify a first subset of devices, where each device in the subset comprises a target sensor and a plurality of additional sensors. The target sensor may be specified, for example, based on user input to the computing system. As a simple example, the user may specify that a humidity sensor is the target sensor. The first subset would then include devices that include a humidity sensor and at least two other sensors (e.g., temperature sensors, pressure sensors, etc.). Once the subset has been identified, at step 620, the computing system collects target sensor data from the target sensor of each device in the subset. Similarly at step 625, additional sensor data is collected from the additional sensors of each device in the subset. The target sensor data and additional sensor data each comprise time series data with sensor measurements. In some embodiments, the target sensor data and additional sensor data are collected at the same time (e.g., as a single data transmission). In other embodiments, the sensor data is streamed to the computing system as it is generated.

At step 630, the computing system trains a predictive model to predict the target sensor data based on the additional sensor data. Techniques of predictive models based on a set of training data vary between the types of model employed; however, these techniques are generally known in the art and, thus not detailed herein. In some embodiments, a subset of the additional sensor data may be used rather than all of the sensor data. This may be especially useful in instances where there are a large number of additional sensors and a correspondingly large set of additional sensor data. To reduce the amount of additional sensor data that may be needed for model training, the computing system may first generate a listing of possible combinations of the additional sensors. Then, the computing system can apply a heuristic search algorithm (e.g., beam search) to the listing in order to identify an optimal combination of the additional sensors with respect to (i) the number of sensors and (ii) the ability to predict the target sensor data based on the additional sensor data.

As noted above devices in the first subset correspond to a first node in the type-of hierarchy generated at step 605. At step 630, the computing system determines the measure of similarity between the first node and other nodes in the type-of hierarchy (e.g., based on the data calculated at step 605). Next, at step 635, the computing system selects a second node in the type-of hierarchy having a measure of similarity above a threshold value. This threshold value may be set during each execution of the method 600, for example, by a user or fixed values may be employed. If multiple nodes are above the threshold value, the node with the maximum measure of similarity may be selected or other selection mechanisms may be used (e.g., random selection). Once the second node has been selected, at step 640, the computing system identifies a second subset of devices in the ecosystem of devices that meet at least three criterion: (a) each device corresponds to the second node in the type-of hierarchy; (b) each device lacks the target sensor; and (c) and each device comprises the plurality of additional sensors. Once the second subset of devices is identified, at step 645, the computing system distributes the predictive model to each device in the second subset of devices. The computing system may use techniques similar to those discussed above with respect to step 530 of FIG. 5 to distribute the predictive models to each device at step 645. Once the predictive models have been deployed, devices in the second subset can generate target sensor data using the predictive model and, thus, provide similar sensor data to the devices in the first subset of devices.

FIG. 7 provides an example of a parallel processing platform 700 that may be utilized to implement the machine learning models and other aspects of the various sensor processing methods discussed herein. This platform 700 may be used in embodiments of the present invention where NVIDIA CUDA™ (or a similar parallel computing platform) is used. The architecture includes a host computing unit (“host”) 705 and a graphics processing unit (GPU) device (“device”) 710 connected via a bus 715 (e.g., a PCIe bus). The host 705 includes the central processing unit, or “CPU” (not shown in FIG. 7), and host memory 725 accessible to the CPU. The device 710 includes the graphics processing unit (GPU) and its associated memory 720, referred to herein as device memory. The device memory 720 may include various types of memory, each optimized for different memory usages. For example, in some embodiments, the device memory includes global memory, constant memory, and texture memory.

Parallel portions of a big data platform and/or big simulation platform may be executed on the platform 700 as “device kernels” or simply “kernels.” A kernel comprises parameterized code configured to perform a particular function. The parallel computing platform is configured to execute these kernels in an optimal manner across the platform 700 based on parameters, settings, and other selections provided by the user. Additionally, in some embodiments, the parallel computing platform may include additional functionality to allow for automatic processing of kernels in an optimal manner with minimal input provided by the user.

The processing required for each kernel is performed by a grid of thread blocks (described in greater detail below). Using concurrent kernel execution, streams, and synchronization with lightweight events, the platform 700 of FIG. 7 (or similar architectures) may be used to parallelize portions of the model based operations performed in training or utilizing the smart editing processes discussed herein. For example, the parallel processing platform 700 may be used to execute multiple instances of a machine learning model in parallel.

The device 710 includes one or more thread blocks 730 which represent the computation unit of the device 710. The term thread block refers to a group of threads that can cooperate via shared memory and synchronize their execution to coordinate memory accesses. For example, in FIG. 7, threads 740, 745 and 750 operate in thread block 730 and access shared memory 735. Depending on the parallel computing platform used, thread blocks may be organized in a grid structure. A computation or series of computations may then be mapped onto this grid. For example, in embodiments utilizing CUDA, computations may be mapped on one-, two-, or three-dimensional grids. Each grid contains multiple thread blocks, and each thread block contains multiple threads. For example, in FIG. 7, the thread blocks 730 are organized in a two dimensional grid structure with m+1 rows and n+1 columns. Generally, threads in different thread blocks of the same grid cannot communicate or synchronize with each other. However, thread blocks in the same grid can run on the same multiprocessor within the GPU at the same time. The number of threads in each thread block may be limited by hardware or software constraints.

Continuing with reference to FIG. 7, registers 755, 760, and 765 represent the fast memory available to thread block 730. Each register is only accessible by a single thread. Thus, for example, register 755 may only be accessed by thread 740. Conversely, shared memory is allocated per thread block, so all threads in the block have access to the same shared memory. Thus, shared memory 735 is designed to be accessed, in parallel, by each thread 740, 745, and 750 in thread block 730. Threads can access data in shared memory 735 loaded from device memory 720 by other threads within the same thread block (e.g., thread block 730). The device memory 720 is accessed by all blocks of the grid and may be implemented using, for example, Dynamic Random-Access Memory (DRAM).

Each thread can have one or more levels of memory access. For example, in the platform 700 of FIG. 7, each thread may have three levels of memory access. First, each thread 740, 745, 750, can read and write to its corresponding registers 755, 760, and 765. Registers provide the fastest memory access to threads because there are no synchronization issues and the register is generally located close to a multiprocessor executing the thread. Second, each thread 740, 745, 750 in thread block 730, may read and write data to the shared memory 735 corresponding to that block 730. Generally, the time required for a thread to access shared memory exceeds that of register access due to the need to synchronize access among all the threads in the thread block. However, like the registers in the thread block, the shared memory is typically located close to the multiprocessor executing the threads. The third level of memory access allows all threads on the device 710 to read and/or write to the device memory. Device memory requires the longest time to access because access must be synchronized across the thread blocks operating on the device.

The embodiments of the present disclosure may be implemented with any combination of hardware and software. For example, aside from parallel processing architecture presented in FIG. 7, standard computing platforms (e.g., servers, desktop computer, etc.) may be specially configured to perform the techniques discussed herein. In addition, the embodiments of the present disclosure may be included in an article of manufacture (e.g., one or more computer program products) having, for example, computer-readable, non-transitory media. The media may have embodied therein computer readable program code for providing and facilitating the mechanisms of the embodiments of the present disclosure. The article of manufacture can be included as part of a computer system or sold separately.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112(f) unless the element is expressly recited using the phrase “means for.”

We claim:

1. A computer-implemented method producing an inductive virtual sensor model of a target device within an ecosystem of devices, the method comprising:
identifying, by a computing system, a first subset of devices in the ecosystem of devices, wherein each device in the first subset of devices comprises a target sensor and a plurality of additional sensors;
collecting, by the computing system, target sensor data from the target sensor of each device in the first subset of devices;
collecting, by the computing system, additional sensor data from the additional sensors of each device in the first subset of devices;
training, by the computing system, a predictive model to predict the target sensor data based on the additional sensor data;
identifying, by the computing system, a second subset of devices in the ecosystem of devices lacking the target sensor, wherein each device in the second subset of devices comprises the plurality of additional sensors; and
distributing, by the computing system, the predictive model to each device in the second subset of devices.

2. The method of claim 1, further comprising:
executing, by one or more devices in the second subset of devices, the predictive model to predict new target sensor data based on new additional sensor data acquired at the one or more devices.

3. The method of claim 1, wherein the computing system is a server-based computing system connected to the first subset of devices and the second subset of devices over one or more networks.

4. The method of claim 3, wherein the one or more networks comprise the Internet.

5. The method of claim 4, wherein all communication between the computing system, to the first subset of devices, and the second subset of devices takes place on the one or more networks.

6. The method of claim 1, wherein the predictive model is distributed to each device in the second subset of devices using a Predictive Model Markup Language (PMML).

7. A computer-implemented method producing an inductive virtual sensor model of a target device within an ecosystem of devices, the method comprising:
grouping devices in the ecosystem of devices into a type-of hierarchy of devices;
determining a measure of similarity between each node in the type-of hierarchy;
identifying a first subset of devices in the ecosystem of devices, wherein each device in the first subset of devices comprises a target sensor and a plurality of additional sensors;
collecting target sensor data from the target sensor of each device in the first subset of devices;
collecting additional sensor data from the additional sensors of each device in the first subset of devices;
training a predictive model to predict the target sensor data based on the additional sensor data;
determining a first node in the type-of hierarchy corresponding to the first subset of devices;
determining a second node in the type-of hierarchy, wherein the measure of similarity between the first node and the second node is above a predetermined threshold;
identifying a second subset of devices in the ecosystem of devices that (a) correspond to the second node in the type-of hierarchy; (b) lack the target sensor; and (c) comprise the plurality of additional sensors; and
distributing the predictive model to each device in the second subset of devices.

8. The method of claim 7, further comprising:
executing, by one or more devices in the second subset of devices, the predictive model to predict new target sensor data based on new additional sensor data acquired at the one or more devices.

9. The method of claim 7, wherein the computing system is a server-based computing system connected to the first subset of devices and the second subset of devices over one or more networks.

10. The method of claim 9, wherein the one or more networks comprise the Internet.

11. The method of claim 10, wherein all communication between the computing system, to the first subset of devices, and the second subset of devices takes place on the one or more networks.

12. The method of claim 7, wherein the predictive model is distributed to each device in the second subset of devices using a Predictive Model Markup Language (PMML).

13. A computer-implemented method producing an inductive virtual sensor model of a target device within an ecosystem of devices, the method comprising:
identifying, by a computing system, a first subset of devices in the ecosystem of devices, wherein each device in the first subset of devices comprises a target sensor and a plurality of additional sensors;
collecting, by the computing system, target sensor data from the target sensor of each device in the first subset of devices;
collecting, by the computing system, additional sensor data from the additional sensors of each device in the first subset of devices;
generating, by the computing system, a listing of possible combinations of the additional sensors;
applying a heuristic search algorithm to the listing of possible combinations to identify an optimal combination of the additional sensors with respect to (i) number of sensors and (ii) ability to predict the target sensor data based on the additional sensor data;
training, by the computing system, a predictive model to predict the target sensor data based on the additional sensor data corresponding to the optimal combination of the additional sensors;
identifying, by the computing system, a second subset of devices in the ecosystem of devices lacking the target sensor, wherein each device in the second subset of devices comprises the optimal combination of the additional sensors; and
distributing, by the computing system, the predictive model to each device in the second subset of devices.

14. The method of claim 13, further comprising:
executing, by one or more devices in the second subset of devices, the predictive model to predict new target sensor data based on new additional sensor data acquired at the one or more devices.

15. The method of claim 13, wherein the heuristic search algorithm is beam search.

16. The method of claim 13, wherein the computing system is a server-based computing system connected to the first subset of devices and the second subset of devices over one or more networks.

17. The method of claim 16, wherein the one or more networks comprise the Internet.

18. The method of claim 17, wherein all communication between the computing system, to the first subset of devices, and the second subset of devices takes place on the one or more networks.

19. The method of claim 13, wherein the predictive model is distributed to each device in the second subset of devices using a Predictive Model Markup Language (PMML).
